(19) United States
(12) Patent Application Publication
(10) Pub. No.: US 2020/0392773 A1
(43) Pub. Date: Dec. 17, 2020

(54) HINGE SYSTEM FOR A STORAGE BIN IN THE CARGO AREA OF A VEHICLE

(71) Applicant: GM GLOBAL TECHNOLOGY OPERATIONS LLC, Detroit, MI (US)

(72) Inventors: Juan Carlos Valencia Flores, Chalco (MX); Neidi Miranda Medina, Azcapotzalco (MX); Cesar Cervantes Sandoval, Tlalnepantla (MX)

(21) Appl. No.: 16/439,809

(22) Filed: Jun. 13, 2019

(51) Int. Cl. E05D 7/12; E05D 3/02; B60R 7/04

(52) U.S. Cl. CPC E05D 7/121; E05Y 2900/538; B60R 7/04; E05D 3/02

(57) ABSTRACT

A hinge system for a storage bin in a cargo area of a vehicle includes a storage bin including a rod member, a nipper hook having an omega-shaped hook section surrounding the rod member, and a storage bin lid attached to lid connecting member of the nipper hook.

### FIELD

The present disclosure relates to a hinge system for a storage bin in the cargo area of a vehicle.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Various storage bins, compartments or other enclosures in vehicles often have lids or other covers. The lids or covers can be lifted, rotated or otherwise moved in order to access the inside of the storage bin or compartment. A hinge system can be used to connect the lid to the storage compartment to permit a user to move the lid to access the inside of the storage bin.

Existing storage bins can be difficult or time consuming to install during the assembly. In addition, existing hinge designs can permit undesired movement of the lid relative to the storage bin during accelerations of the vehicle.

### SUMMARY

In an exemplary aspect, a hinge system for a storage bin in a cargo area of a vehicle includes a storage bin including a rod member, a nipper hook having an omega-shaped hook section surrounding the rod member, and a storage bin lid attached to lid connecting member of the nipper hook.

In another exemplary aspect, the omega-shaped hook section includes ramps sections.

In another exemplary aspect, the ramp sections each diverge from open ends of the omega-shaped hook section.

In another exemplary aspect, the nipper hook further includes a lever arm.

In another exemplary aspect, the lever arm extends from a closed end of the omega-shaped hook section.

In another exemplary aspect, the nipper hook further includes an elastic arm that substantially conforms to the omega-shaped section.

In another exemplary aspect, the elastic arm includes a proximal end connected to the lid connecting member.

In another exemplary aspect, the elastic arm includes a distal end having a protrusion that extends inward from the omega-shaped hook section.

In another exemplary aspect, the rod member defines a complementary recess that is adapted to receive the protrusion when the storage bin lid is rotatably positioned at a predetermined position relative to the rod member.

In another exemplary aspect, the rod member defines a plurality of complementary recesses.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is an elevation view of a hook hinge for an existing hinge system for a storage bin lid in the cargo area of a vehicle;

FIG. 2 is a perspective view of a storage bin and lid incorporating the hook hinge of FIG. 1 into the existing hinge system for a storage bin lid in the cargo area of a vehicle;

FIG. 3. is a close-up view of the hinge system of FIG. 2;

FIG. 4 is an elevation, close-up, cross-sectional view of the hinge system of FIG. 2;

FIG. 5 is a close-up perspective view of a sky hook for the hinge system of FIG. 2;

FIG. 6 is a perspective view of a nipper hook for an exemplary hinge system for a storage bin lid in the cargo area of a vehicle in accordance with the present disclosure;

FIG. 7 is a perspective view of a storage bin and lid incorporating the nipper hook of FIG. 6 into the exemplary hinge system for a storage bin lid in the cargo area of a vehicle in accordance with the present disclosure;

FIG. 8 is a close-up view of the exemplary hinge system of FIG. 7;

FIG. 9 is a close-up cross-section view of the exemplary hinge system of FIG. 7;

FIG. 10 is a cross-section view of an initial configuration of an installation process for an exemplary hinge system for a storage bin lid in the cargo area of a vehicle in accordance with the present disclosure;

FIG. 11 is a cross-section view of an intermediate configuration of an installation process for the exemplary hinge system of FIG. 10;

FIG. 12 is a cross-section view of a final configuration of an installation process for the exemplary hinge system of FIG. 10;

FIG. 13 is a cross-section perspective view of an exemplary hinge system for a storage bin lid in the cargo area of a vehicle in accordance with the present disclosure;

FIG. 14 is a perspective view of a rod member of the hinge system of FIG. 13; and

FIG. 15 is a perspective view of a configuration in a removal process for an exemplary hinge system for a storage bin lid in the cargo area of a vehicle in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner.

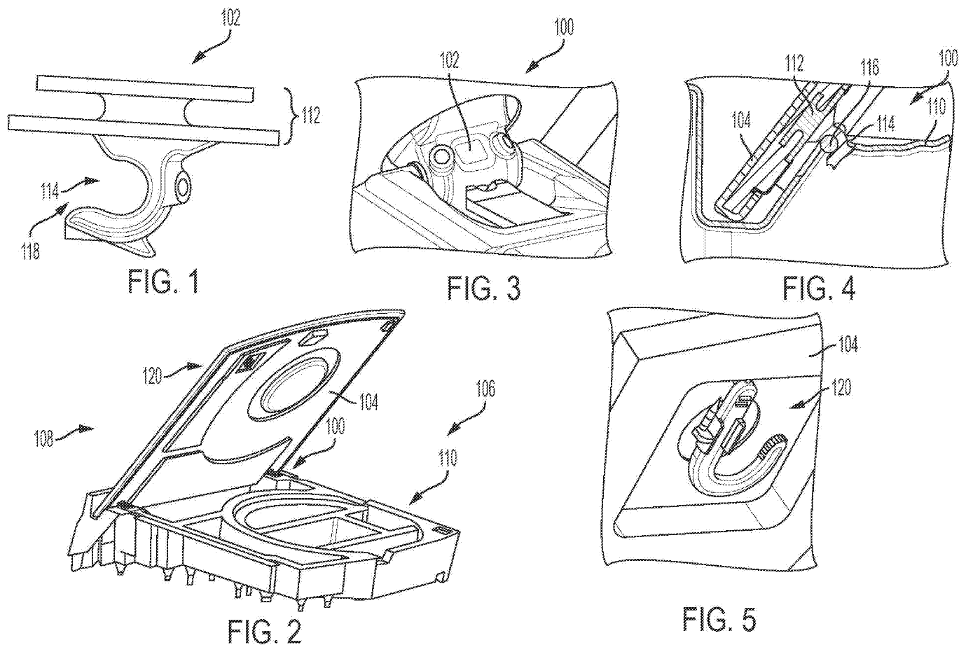

Referring now to the drawings, wherein like reference numbers correspond to like or similar components throughout the several figures, FIGS. 1-5 provide multiple views of an existing hinge system 100 incorporating a hook hinge 102 integrated into a storage bin lid 104 for a storage bin 110 in the cargo area 106 of a vehicle 108. The hook hinge 102 includes a lid connecting member 112 and a downwardly depending hook 114. The lid connecting member 112 may be integrated into the storage bin lid 104 by, for example, being molded as part of the lid 104. As illustrated in FIG. 4, the hook 114 engages a rod member 116 of the storage bin 110. The hook 114 defines an opening 118 through which the rod member 116 may pass during installation and/or removal of the storage bin lid 104 with respect to the vehicle. The hinge system 100 further includes a sky hook 120 that is attached to the storage bin lid 104. The sky hook 120 is adapted to engage another vehicle component (not shown) to hold the storage bin lid 104 in a fully open configuration. The existing hinge system 100 poses a number of challenges. In particular, installation and/or removal of the hook hinge 102 from the storage bin rod 116 is difficult. Further, the existing hinge system 100 requires the use of a sky hook 120 in order to hold the storage bin lid 104 in an open configuration.

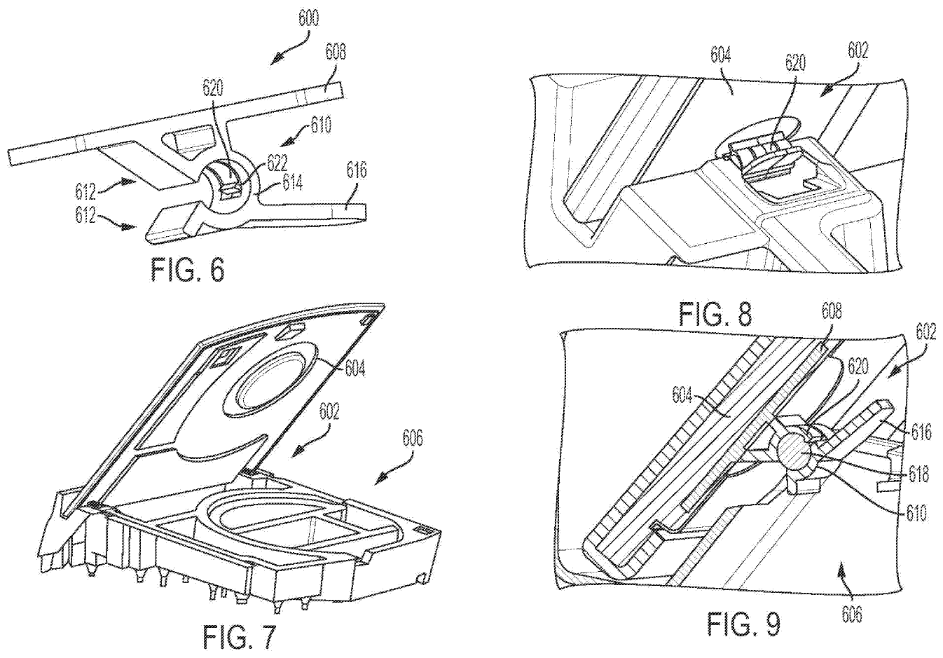

Referring now to FIGS. 6-9, an exemplary hinge system 602 in accordance with the present disclosure is described. FIG. 6 is a perspective view of a nipper hook 600 for an exemplary hinge system 602 for a storage bin lid 604 of a storage bin 606 of a vehicle in accordance with the present disclosure. FIG. 7 is a perspective view of the storage bin and lid 604 incorporating the nipper hook 600 of FIG. 6 into the exemplary hinge system 602 for the storage bin lid 604 in the cargo area of a vehicle. The nipper hook 600 includes a lid connecting member 608 which, as clearly illustrated in FIG. 9, may be embedded within the storage bin lid 604. It is to be understood that the lid connecting member 608 may be fixed to the storage bin lid 604 in any manner without limitation and remain within the scope of the present disclosure. The nipper hook 600 further includes an “omega-shaped” hook section 610 extending from the lid connecting member 608. The omega-shaped hook section 610 includes ramp sections 612 which each diverge from the open ends of the omega-shaped hook section 610. The nipper hook 600 further includes a lever arm 616 extending from the closed end 614 of the omega-shaped hook section 610. As clearly illustrated in FIGS. 8 and 9, when fully installed, the omega-shaped section 610 of the nipper hook 600 surrounds a rod member 618 of the storage bin 606. In this manner, the nipper hook 600 operates as a hinge with enables the storage bin lid 604 to pivot relative to the rod member 618. In comparison with conventional hinge designs which may rely upon a “c-shaped” hook section, the “omega-shaped” hook section provides a significant advantage in that the retention force for reliably holding the storage bin lid 604 in position within a vehicle experiencing high acceleration forces is greatly improved.

The nipper hook 600 further includes an elastic arm 620 having a proximal end which extends from the lid connecting member 608 and which substantially conforms to the shape of the omega-shaped hook section 610. A distal end of the elastic arm 620 includes a protrusion 622 that extends inward from the omega-shaped hook section 610. The rod member 618 includes a plurality of complementary recesses 624 which are each adapted to receive the protrusion 622 when the storage bin lid 604 is rotatably positioned at predetermined positions.

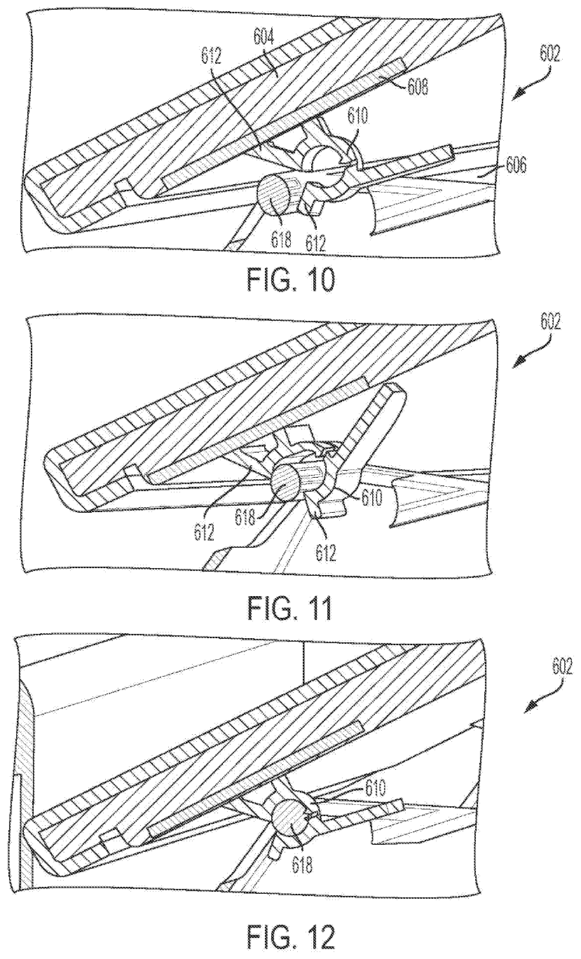

Referring now to FIGS. 10-12, the installation process for the exemplary hinge system 602 is described. The lid connecting member 608 of the nipper hinge 600 is attached to the storage bin lid 604. FIG. 10 is a cross-section view of an initial configuration of an installation process for the hinge system 602. An installer (not shown) may position the storage bin lid 604 in a vehicle such that the ramp sections 612 contact the rod member 618 of the storage bin 606. The material of the nipper hinge 600 is flexibly elastic such that when the installer pushes the storage bin lid 604 toward the rod member 618, the ramp sections 612 spread apart and cause the omega-shaped hook section 610 to expand as illustrated in FIG. 11. Continued pressure applied by the installer moving the storage bin lid 604 further toward the rod member 618 such that the ramp sections 612 move past the rod member 618, the elasticity of the material of the omega-shaped hook section 610 results in the ramp sections 612 substantially returning to their original position such that the rod member 618 is enclosed by the omega-shaped section 610. In this manner, the exemplary hinge system 602 enables simple and easy installation of the storage bin lid 604 into a pivotally hinged connection to the storage bin 606.

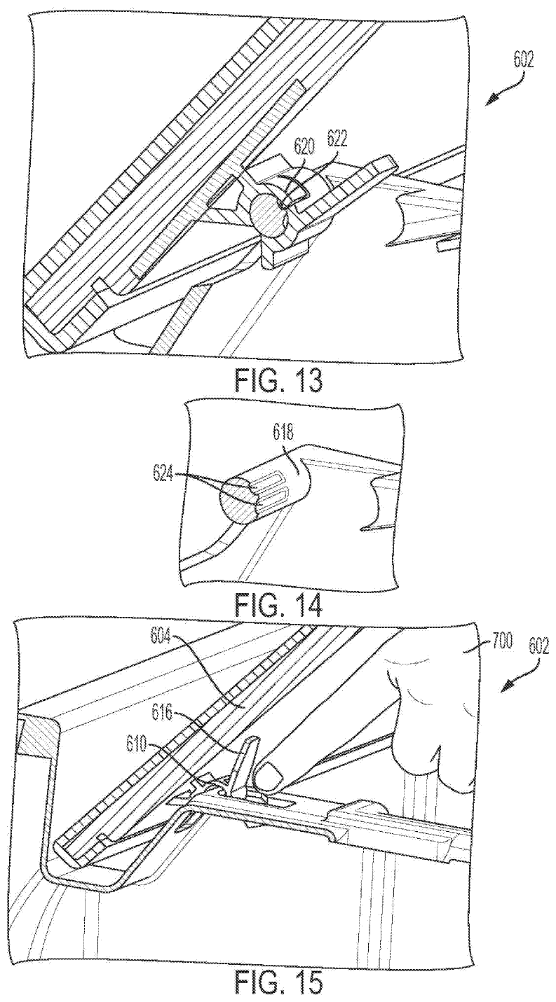

FIG. 13 is a cross-section perspective view of the exemplary hinge system 602 and FIG. 14 is a perspective view of the rod member of the hinge system of FIG. 13 without the exemplary hinge system 602 installed in the vehicle. The rod member 618 includes a plurality of recesses 624 which are each adapted to receive the protrusion 622 at the distal end of the elastic arm 620. As the storage bin lid 604 rotates upwardly from a position which fully closes off access to the storage bin, the protrusion 622 successively engages each of the plurality of recesses 624. In this manner, the storage bin lid 604 may be held open in any of a plurality of positions without requiring the use of any other components, such as, for example a sky hook 120 as required by conventional storage bin lid hinge systems.

FIG. 15 is a perspective view of a removal process for an exemplary hinge system 602 for a storage bin lid 604 in the cargo area of a vehicle in accordance with the present disclosure. A user 700 may engage the lever arm 616 and move the lever arm 616 upward which causes the omega-shaped hook section 610 to flexibly and elastically open and spread the ramp sections 612 apart which enables the rod member 618 of the storage bin 606 to move out of the omega-shaped hook section 610. In this manner, the nipper hook 600 may easily be disengaged from the rod member 618 which enables the storage bin lid 604 to be removed from the storage bin 606 and the vehicle, if desired.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A hinge system for a storage bin in a cargo area of a vehicle, the system comprising:
a storage bin including a rod member;
a nipper hook having an omega-shaped hook section surrounding the rod member; and
a storage bin lid attached to lid connecting member of the nipper hook.

2. The system of claim 1, wherein the omega-shaped hook section comprises ramps sections.

3. The system of claim 2, wherein the ramp sections each diverge from open ends of the omega-shaped hook section.

4. The system of claim 1, wherein the nipper hook further comprises a lever arm.

5. The system of claim 4, wherein the lever arm extends from a closed end of the omega-shaped hook section.

6. The system of claim 1, wherein the nipper hook further comprises an elastic arm that substantially conforms to the omega-shaped section.

7. The system of claim 6, wherein the elastic arm comprises a proximal end connected to the lid connecting member.

8. The system of claim 6, wherein the elastic arm comprises a distal end having a protrusion that extends inward from the omega-shaped hook section.

9. The system of claim 8, wherein the rod member defines a complementary recess that is adapted to receive the protrusion when the storage bin lid is rotatably positioned at a predetermined position relative to the rod member.

10. The system of claim 9, wherein the rod member defines a plurality of complementary recesses.

11. A hinge for a hinge system for a storage bin in a cargo area of a vehicle having a storage bin including a rod member and a storage bin lid, the hinge comprising:
a nipper hook having an omega-shaped hook section surrounding the rod member and a lid connecting member attached to the storage bin lid.

12. The hinge of claim 11, wherein the omega-shaped hook section comprises ramps sections.

13. The hinge of claim 12, wherein the ramp sections each diverge from open ends of the omega-shaped hook section.

14. The hinge of claim 11, wherein the nipper hook further comprises a lever arm.

15. The hinge of claim 14, wherein the lever arm extends from a closed end of the omega-shaped hook section.

16. The hinge of claim 11, wherein the nipper hook further comprises an elastic arm that substantially conforms to the omega-shaped section.

17. The hinge of claim 16, wherein the elastic arm comprises a proximal end connected to the lid connecting member.

18. The hinge of claim 16, wherein the elastic arm comprises a distal end having a protrusion that extends inward from the omega-shaped hook section.

19. The hinge of claim 18, wherein the rod member defines a complementary recess that is adapted to receive the protrusion when the storage bin lid is rotatably positioned at a predetermined position relative to the rod member.

20. The hinge of claim 19, wherein the rod member defines a plurality of complementary recesses.
